(19) United States
(12) Patent Application Publication
(10) Pub. No.: US 2008/0273764 A1
(43) Pub. Date: Nov. 6, 2008

(54) Personal Gesture Signature

(75) Inventor: Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,798

(22) PCT Filed: Jun. 27, 2005
(86) PCT No.: PCT/IB05/52118

§ 371 Date: Dec. 18, 2006

(30) Foreign Application Priority Data
Jun. 29, 2004 (EP) 04103048.7

(51) Int. Cl. G06K 9/00

(52) U.S. Cl. 382/118

(57) ABSTRACT

The present invention relates to a system and a method of verifying the identity of a user and based thereon controlling access to user specific data or actions, said method verifies said identity by receiving an identification key, and based on a comparison with a pre stored reference identification key access to said user specific data or action is controlled, said identification key being obtained by the steps of: visually recording a gesture by recording the trajectory of a hand of said user when the user uses said hand for performing a gesture, extracting gesture characteristics from said visually recorded gesture, performing said verification by comparing an identification key comprising said gesture characteristics with a pre stored reference identification key comprising reference gesture characteristics. An advantage of the gesture signature over “static” approaches like iris scans or face recognition is reliability. The dynamic data inherent in a gesture signature strongly increases the verification confidence.

The present invention relates to a method of verifying the identity of a user based on a gesture performed by said user. The invention further relates to a system of verifying the identity of a user.

Today's digital user verification approaches are either in principle insecure or inconvenient. A personal password or PIN can be stolen or overseen so that a fraud can misuse it. Additional security by using session-dependent codes (e.g. TAN) adds inconveniences for storing and managing these codes. Therefore, biometric features are envisioned as a personal yet convenient way to overcome these drawbacks. Nevertheless, many of these approaches have shortcomings:

Voice Print—This approach is not yet perfectly reliable, it could be a good choice, in principle, as it makes use of a microphone, which mostly is present in many relevant devices. Furthermore, speech is in a variety of cases a natural modality of communication. However, it might be awkward for a user to speak a verification phrase aloud at a shop checkout point, or some devices might still not have microphones (an example of such a device could e.g. be a remote control).

Fingerprint—This approach is considered secure enough but requires additional hardware. Further, it requires a significant larger amount of storage space on devices.

Iris Scan, Face Recognition, etc.—Such advanced biometric user verification approaches either require dedicated additional hardware and/or are quite expensive in terms of computational resources.

Digitized handwriting signature—For payment applications this can be a good choice. Touch sensitive displays for recording the handwriting signature are also available in many devices. E.g. in U.S. Pat. No. 6,539,101 pens/styli with embedded biometric features (e.g. finger print scanners) are described. This information is then combined with handwriting based user authentication to enhance security.

It is therefore an object to provide devices and method solving the above mentioned problems.

This is obtained by a method of verifying the identity of a user, and based thereon controlling access to user specific data or actions, said method verifies said identity by receiving an identification key, and based on a comparison with a pre stored reference identification key access to said user specific data or action is controlled, said identification key being obtained by the steps of:

visually recording a gesture by recording the trajectory of a hand of said user when the user uses said hand for performing a gesture,

extracting gesture characteristics from said visually recorded gesture,

performing said verification by comparing an identification key comprising said gesture characteristics with a pre stored reference identification key comprising reference gesture characteristics.

The most significant advantage of the gesture signature over “static” approaches like iris scans or face recognition is reliability. The dynamic data inherent in a gesture signature strongly increases the verification confidence.

Further advantages separated in the categories security, reliability, convenience and bill of material are:

Security: By combining personal patterns with personal dynamic movements the highest level of security can be technically achieved.

Reliability: Since it is not necessary to record small details, but only rather crude motions, a gesture signature can be acquired reliably also in rather adverse conditions (lighting conditions, noise).

Convenience: A gesture can be recorded over a distance, or by a personal handheld device with the most common and widespread hardware, namely by video.

Bill of material: The detection of movements does not so much rely on the accurate recording of particular small details. Therefore, simple and cheap recording equipment can do the job.

In an embodiment said video recording means is placed in a wand, said wand being held in the hand of said user when the user performs the gesture, and the trajectory of said hand is obtained from the video signal recorded by said video recording means. A UI (user interface) Wand promises to be a widespread commodity for lean-back and in-a-distance interaction with devices. It is therefore faster and more convenient to stick to the UI Wand also for verification issues at a checkout when the customer already used it as virtual shopping cart. But the gesture signature is definitely much more convenient than a handwriting Signature in the living room scenario with a person controlling entertainment equipment, selecting content in a relaxed lean-back mood and verifying this at some points in time. This particularly includes home shopping via (interactive) television.

In an embodiment said wand comprises a protection system ensuring that only a registered user can validly use said wand. Thereby a wand can only be used by the registered user, and features of the wand can further be used to uniquely identify the gestures of the user.

Combining the gesture signature with a unique electronic ID of the Wand can ensure even further enhanced security. Since the verification is only valid with a particular wand, misuse of the wand by unauthorized people is made almost impossible. Further misuse of low-level digital personal ID data by a hacker is made almost impossible when the Wand cryptographically signs each given signature with transaction specific details. This can include date and time but also data that is exchanged between the administering application and transaction server and the Wand specifically on this particular transaction. This eliminates the use of the transmitted digital verification data for any other transaction.

In an embodiment said video recording means is placed around the user pointing towards the hand of said user for visually recording the hand during the gesture, and the trajectory of the gesture is extracted from said recorded gesture. Thereby the user does not have to carry any special tool, it is in the surroundings e.g. in the stores the recording means has to be placed. Thereby it is made cheaper for the user to start using the gesture as a user signature.

The invention further relates to a computer readable medium having stored therein instructions for causing a processing unit to execute the method described above.

The invention further relates to a verification system for verifying the identity of a user and based thereon controlling access to user specific data or actions, said verification system verifies said identity by receiving an identification key and based on a comparison with a pre stored reference identification key access to said user specific data or action is controlled, said verification system comprises:

video recording means for visually recording a gesture by recording the trajectory of a hand of said user when the user uses said hand for performing a gesture,

processing means for extracting gesture characteristics from said visually recorded gesture,

processing means for performing said verification by comparing an identification key comprising said gesture characteristics with a pre stored reference identification key comprising reference gesture characteristics.

In an embodiment said system further comprises:

a wand comprising said video recording means, said wand being adapted to be held in the hand of said user when the user performs the gesture,

processing means for obtaining the trajectory of said hand from the video recorded by said video recording means in said wand.

In an embodiment said system further comprises:

video recording means being adapted to be placed around the user for visually recording the hand of said user when the user performs the gesture,

processing means for obtaining the trajectory of said hand from the video recorded by said video recording means.

In the following preferred embodiments of the invention will be described referring to the figures, where

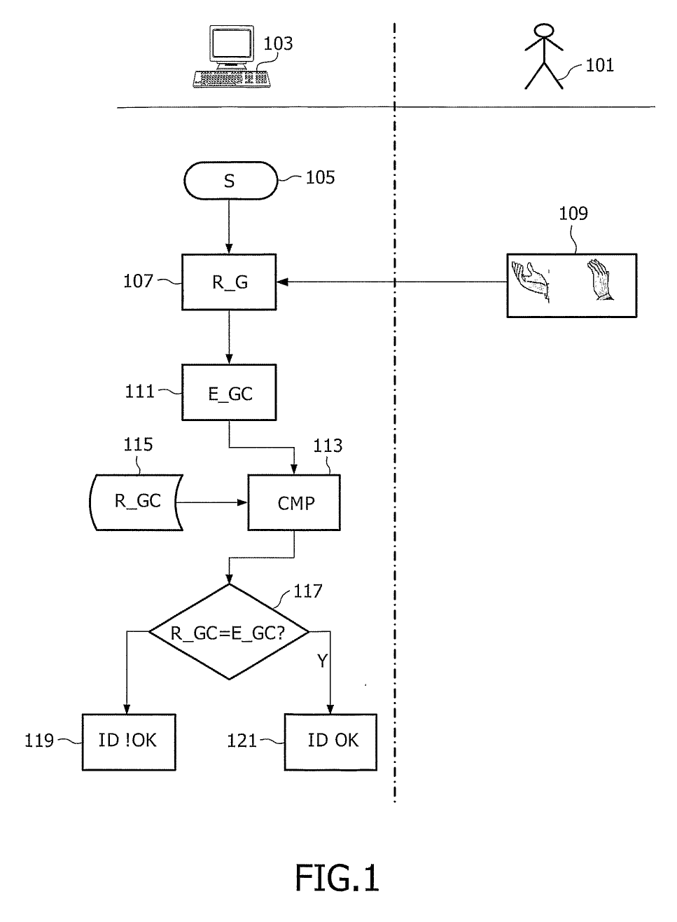

FIG. 1 illustrates a method of verifying the identity of a user using gesture identification,

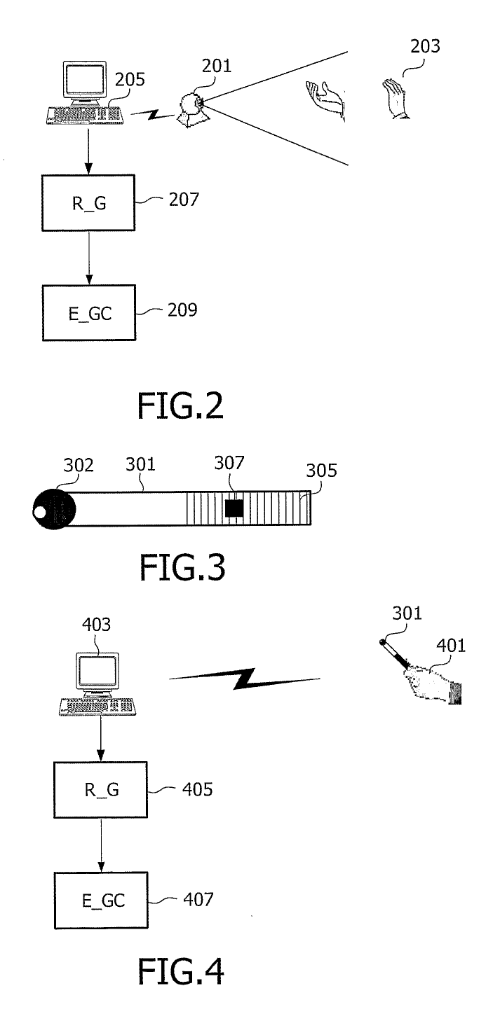

FIG. 2 illustrates a first method of recording a gesture,

FIG. 3 illustrates a UI wand to be used for recording a gesture,

FIG. 4 illustrates a second method of recording a gesture.

In FIG. 1 a method of verifying the identity of a user using gesture identification is illustrated. The user is illustrated in 101, and in 103 a computer performing the method is illustrated. An example is given where a user gesture is used to verify the identity of the user 101. First, in step 105 the verification is started. This is performed by starting the visually recording of the gesture by starting the video recording means. Next, in step 107 the video recording means records the gesture performed by the user 101, the gesture being performed by the user's hands as illustrated in box 109. In order to know when the gesture is finished this could e.g. be signalled by a specific gesture or by a transmitting a signal to the computer 103 via a piece of hardware communicating with the computer e.g. a remote control. In step 111 gesture characteristics are extracted (E_GC) from the visually recorded gesture. This could e.g. be performed by an image recognition system looking for specific characteristics in the recorded video. Next, in step 113 the gesture characteristics are compared (CMP) to reference gesture characteristics (R_GC) 115, which have been pre stored in the memory of the computer 103. In step 117 it is then determined whether the extracted gesture characteristics are equal to the pre stored gesture characteristics. If the gestures are equal or maybe just have substantial similarities, then in step 121 the identity of the user has been verified as being OK, and the user is then allowed to perform specific action and/or is allowed to access user specific data e.g. by reading or modifying the data. If the gestures are not equal or have substantial differences, then in step 119 the identity of the user is not OK (ID !OK), and the user is not allowed to perform specific action and/or is not allowed to access user specific data e.g. by reading or modifying the data.

Two general approaches of recording the raw data of a gesture are described below being respectively one referred to as an external gesture recorder and a hand held gesture recorder.

The external gesture recorder has fixed sensors. There are several known systems that try to derive e.g. pointing information from an external video signal or a number of external video signals obtained from video recording means placed around the user to obtain the trajectory of the hands of the user. Similar systems exist to derive sign language information from video signals. It is essential to all such systems to abstract as much as possible from the individual performance of a gesture in order to filter out the generic underlying motion. For the sign language systems, the personal variation is rather considered an obstacle in the task of classifying a gesture. In a system according to the present invention, a different goal has to be achieved. The raw data is not compressed as much as it may be optimal for “recognition”. An advantage of having external video recording means is that they can furthermore supply additional face recognition data, which might be combined into one compound identification system together with the person verification based on the gesture.

An example of an external gesture recorder is illustrated in FIG. 2, in this example a camera 201 points towards the hands 203 of the user and records the gesture being performed by the user. The camera could be connected to communicate with a computer, where the computer is adapted to perform any additional processing of the recorded gesture. This step is illustrated as after having recorded the gesture 207 as a video signal, the gesture characteristics are extracted 209 (E_GC) from the recorded video signal. One or more cameras could be used based on e.g. from which positions the gesture characteristics should be able to be extracted.

The hand-held system has built-in sensors to record the motion of the device. Known systems are e.g. gloves or 3D mice for use in virtual reality systems, or light pens to write on a (distant) screen. But still, as compared to recognition of a generic gesture, the task of this invention is different.

According to the present invention a UI wand 301 as illustrated in FIG. 3 could be used. The wand 301 comprises a camera 303 in one end and a handle 305 in the other end. In the illustration the wand further comprises a button 307, which e.g. could be activated to indicate the beginning of a gesture or alternatively the end of a gesture after which the gesture characteristics can be extracted. The wand could e.g. comprise the functionalities of the computer 205 inside its housing, or it could be adapted to e.g. wirelessly transmit detected gesture data to an external computer. When using the UI Wand with its built-in video camera, the gesture characteristics extraction step requires the detection of movement elements in the raw video images. By adaptation of object tracking algorithms, the movement of the camera can be reconstructed (at least in a 2-dimensional projection). This data would then serve as input data for verification. There could be several built-in sensors on which to build the system. Existing systems for the tracking 3D gestures are typically based on magnetic or ultrasound positioning. Combining them with video-based motion analysis can enhance the system performance for certain applications. The raw information about the motion of the wand could be fed into a verification engine, e.g. similar to those being used for user verification based on handwriting. The necessary modifications only include adaptation of the underlying classification models to the increased/diversified dimensionality of the input data.

In FIG. 4 a second method of recording a gesture using a UI wand 301 as illustrated in FIG. 3 is shown. The user performs the gesture while holding the UI wand 301 in his hand 401. The gesture data is transmitted to a computer 403, where the computer is adapted to perform any additional processing of the recorded gesture. This processing could be that after having recorded the gesture in step 405 as a video signal, the gesture characteristics are extracted in step 407 (E_GC) from the recorded video signal.

The UI Wand represents an excellent example, where the gesture signature blends in very naturally with other related activities such as controlling home entertainment equipment or shopping both in the real world and virtually.

The UI wand could be a user interface device for control of home entertainment equipment. By simply pointing at menus and device features (such as buttons) it is easy to select functionality and conduct certain tasks. Further gestures are also used to supply additional information (e.g. pointing at a loudspeaker and then circling clockwise to increase the volume). Whenever the user wants to access pay-per-use or age-restricted content, he must provide some sort of identification. Besides the fact that today's systems do not offer much except a PIN code that must be entered, the definite identification of the user (i.e. verification) can also be achieved by the proposed gesture signature. The user simply writes some sort of personal symbol “into the air”, which will then be processed accordingly.

In a shop, customers use the UI Wand as a virtual shopping cart. While strolling through the aisles of the store, they simply point at desired articles, indicate numbers by gestures, and proceed further. At the checkout, the customers can re-check what they “put in the shopping cart” at a dedicated display, make last-minute adjustments to it and pay. Making the personal gesture as a signature closes the deal in a secure and yet very convenient way.

The gestures mentioned above could be both two dimensional and three dimensional. Generally, the user performs a gesture trajectory in a three dimensional space. The gesture trajectory could either be projected in two dimensions in which the gesture data is recorded. Alternatively, all three dimensions of the gesture trajectory are detected, and the gesture data is based on all three dimensions.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of verifying the identity of a user, comprising:
receiving an identification key; and controlling access to user specific data or actions based on a comparison between the identification key and a pre stored reference identification key, said identification key being obtained by visually recording a gesture by recording the trajectory of a hand of said user, when the user uses said hand for performing a gesture,
extracting gesture characteristics from said visually recorded gesture, and
performing said verification by comparing an identification key comprising said gesture characteristics with a pre stored reference identification key comprising reference gesture characteristics.

2. A method according to claim 1, wherein said recording is performed using a wand, said wand being held in the hand of said user when the user performs the gesture, and the trajectory of said hand is obtained from a recorded video signal.

3. A method according to claim 2, wherein said wand comprises a protection system ensuring that only a registered user can validly use said wand.

4. A method according to claim 1, further comprising video recording means placed around the user pointing towards the hand of said user for visually recording the hand during the gesture, wherein the trajectory of the gesture is extracted from said recorded gesture.

5. A computer readable medium having stored instructions for causing a processing unit to verify the identity of a user, comprising:
receiving an identification key; and
controlling access to user specific data or actions based on a comparison between the identification key and a pre stored reference identification key, said identification key being obtained by visually recording a gesture by recording the trajectory of a hand of said user, when the user uses said hand for performing a gesture, extracting gesture characteristics from said visually recorded gesture, and performing said verification by comparing an identification key comprising said gesture characteristics with a pre stored reference identification key comprising reference gesture characteristics.

6. A verification system for verifying the identity of a user, comprising:
means for receiving an identification key;
controlling access to user specific data or actions based on a comparison between the identification key and a pre stored reference identification key;
video recording means for visually recording a gesture by recording the trajectory of a hand of said user when the user uses said hand for performing a gesture;
processing means for extracting gesture characteristics from said visually recorded gesture; and
processing means for performing said verification by comparing an identification key comprising said gesture characteristics with a pre stored reference identification key comprising reference gesture characteristics.

7. A verification system according to claim 6, wherein said system further comprises:
a wand comprising said video recording means, said wand being adapted to be held in the hand of said user when the user performs the gesture, and
processing means for obtaining the trajectory of said hand from the video recorded by said video recording means in said wand.

8. A verification system according to claim 6, wherein said system further comprises:
video recording means being adapted to be placed around the user for visually recording the hand of said user when the user performs the gesture, and
processing means for obtaining the trajectory of said hand from the video recorded by said video recording means.
